(19) United States
(12) Patent Application Publication
(10) Pub. No.: US 2026/0003306 A1
(43) Pub. Date: Jan. 1, 2026

(54) TONER CONTAINER AND IMAGE FORMING APPARATUS

(71) Applicants: Tatsuya KUBO, Kanagawa (JP); Kentaro NODERA, Kanagawa (JP); Hideo YOSHIZAWA, Saitama (JP); Tatsuya OHHIRA, Kanagawa (JP)

(72) Inventors: Tatsuya KUBO, Kanagawa (JP); Kentaro NODERA, Kanagawa (JP); Hideo YOSHIZAWA, Saitama (JP); Tatsuya OHHIRA, Kanagawa (JP)

(21) Appl. No.: 19/130,119

(22) PCT Filed: Dec. 22, 2023
(86) PCT No.: PCT/IB2023/063168

§ 371 Date: May 15, 2025

(30) Foreign Application Priority Data
Jan. 25, 2023 (JP) 2023-009351

(51) Int. Cl. G03G 15/08; G03G 15/01; G03G 21/16

(52) U.S. Cl. CPC G03G 15/0872; G03G 15/0121; G03G 15/0189; G03G 15/0891; G03G 15/0898; G03G 21/1633; G03G 2221/1654

(57) ABSTRACT

A toner container is manually attachable to a mount of a body of an image forming apparatus horizontally in an attachment direction and detachable from the mount horizontally in a detachment direction. The toner container includes a bottom portion and a projection. The projection protrudes downward to a lowest position in the bottom portion of the toner container in a posture when the toner container is attached to and detached from the mount, and slides on a surface of the mount when the toner container is attached to and detached from the mount. A length from a downstream end of the bottom portion in the attachment direction to the projection is within a range of 37.5 to 80 mm.

### TECHNICAL FIELD

Embodiments of the present disclosure relate to a toner container that stores toner therein, and an image forming apparatus such as a copier, a printer, a facsimile, or a multifunction peripheral thereof including the toner container.

### BACKGROUND ART

Image forming apparatuses such as copiers and printers are widely known in which a toner container attached to and detached from a body of an image forming apparatus is disposed (see Patent literature (PTL) 1, for example).

Specifically, the toner container typically includes a substantially cylindrical container body and a cap in PTL 1. The container body has an opening portion in a head portion and a spiral projection formed on an inner circumferential surface of the container body. The cap has a toner ejection port (supplying port) formed at its bottom portion, and the head portion of the container body is inserted therein. A part of the bottom portion of the cap is formed to protrude downward. Such a toner container is manually pushed in and set to slide on a rail of a body of an image forming apparatus with the cap as a leading end. In the toner container set in the body of the image forming apparatus, the container body is driven to rotate to convey toner in the container body toward the opening portion. The toner ejected from the opening portion of the container body is ejected to the outside of the container body via the toner ejection port of the non-rotating cap. The toner ejected from the toner container is supplied to a developing device by a toner supply device.

### CITATION LIST

### [Patent Literature]

### [PTL 1]

Japanese Patent No. 5999479

### SUMMARY OF INVENTION

### [Technical Problem]

When a toner container in the related art is pulled out of a body of an image forming apparatus by a user, the posture of the toner container tends to be significantly unbalanced. In a case where the posture of the toner container is significantly unbalanced as such, toner remaining in the toner container may leak to the outside. The present disclosure is made in order to solve an inconvenience as described above, and an object of the present disclosure is to provide a toner container and an image forming apparatus in which an inconvenience that the posture of the toner container is unbalanced is not likely to occur when the toner container is pulled out from a body of the image forming apparatus by a user.

### [Solution to Problem]

A toner container according to the present disclosure is manually attachable to a mount of a body of an image forming apparatus horizontally in an attachment direction and detachable from the mount horizontally in a detachment direction. The toner container includes a bottom portion and a projection. The projection protrudes downward to a lowest position in the bottom portion of the toner container in a posture when the toner container is attached to and detached from the mount, and slides on a surface of the mount when the toner container is attached to and detached from the mount. A length from a downstream end of the bottom portion in the attachment direction to the projection is within a range of 37.5 to 80 mm.

### [Advantageous Effects of Invention]

According to the present disclosure, a toner container and an image forming apparatus can be provided in which an inconvenience that the posture of the toner container is unbalanced when the toner container is pulled out of the body of the image forming apparatus by a user is not likely to occur.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a schematic view of an image forming apparatus according to an embodiment of the present disclosure.

FIG. 2 is a cross-sectional view of an image forming device of the image forming apparatus in FIG. 1.

FIG. 3 is a diagram illustrating a toner container installed on a toner supply device, according to an embodiment of the present disclosure.

FIG. 4 is a perspective view of toner containers installed on a mount, according to an embodiment of the present disclosure.

FIG. 5 is a perspective view of a toner container according to an embodiment of the present disclosure.

FIG. 6 is a front view of a toner container viewed from downstream in an attachment direction of the toner container according to an embodiment of the present disclosure.

FIGS. 7A to 7D are diagrams illustrating an operation of pulling out a toner container from a body of an image forming apparatus, according to an embodiment of the present disclosure.

FIGS. 8A to 8D are diagrams illustrating an operation of pulling out a toner container from a body of an image forming apparatus, according to a comparative example.

FIGS. 9A to 9D are enlarged views of a bottom portion of a cap of a toner container according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

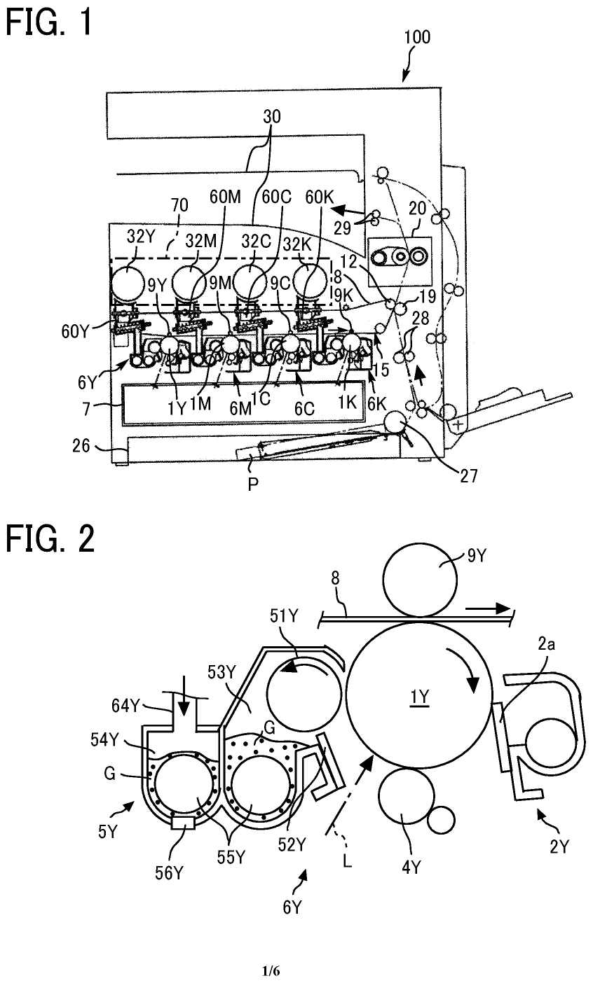

A configuration and operation of an image forming apparatus 100 is described below. As illustrated in FIG. 1, four toner containers 32Y, 32M, 32C, and 32K corresponding to colors of yellow, magenta, cyan, and black, respectively, are detachably (i.e., replaceably) arranged in a toner container housing 70 (see FIG. 4) above a body of the image forming apparatus 100. These toner containers 32Y, 32M, 32C, and 32K are manually attached to and detached from the body of the image forming apparatus 100 by an operator such as a user. An intermediate transfer unit 15 is disposed below the toner container housing 70. Image forming devices 6Y, 6M, 6C, and 6K corresponding to colors of yellow, magenta, cyan, and black, respectively, are arranged side by side to face an intermediate transfer belt 8 of the intermediate transfer unit 15. Toner supply devices 60Y, 60M, 60C, and 60K are disposed below the toner containers 32Y, 32M, 32C, and 32K, respectively. Toner contained in the toner containers 32Y, 32M, 32C, and 32K is supplied (replenished) by the toner supply devices 60Y, 60M, 60C, and 60K, into developing devices of the image forming devices 6Y, 6M, 6C, and 6K, respectively.

With reference to FIG. 2, the image forming device 6Y for yellow includes a photoconductor drum 1Y, a charging device 4Y, a developing device 5Y, a cleaning device 2Y, and an electric-charge removing device disposed around the photoconductor drum 1Y. Image forming processes (i.c., charging process, exposure process, development process, transfer process, cleaning process, and electric-charge removing process) are executed on the photoconductor drum 1Y. Thus, a yellow toner image is formed on the surface of the photoconductor drum 1Y.

The other three image forming devices 6M, 6C, and 6K have substantially the same configuration as that of the image forming device 6Y for yellow except for the color of toner used therein and form magenta, cyan, and black toner images, respectively. Only the image forming device 6Y for yellow is described below and descriptions of the other three image forming devices 6M, 6C, and 6K are omitted to avoid redundancy.

As illustrated in FIG. 2, the photoconductor drum 1Y is driven to rotate clockwise in FIG. 2 by a drive motor. The charging device 4Y uniformly charges the surface of the photoconductor drum 1Y (a charging process). When the surface of the photoconductor drum 1Y reaches a position at which the surface of the photoconductor drum 1Y is irradiated with a laser beam L emitted from an exposure device 7 (see FIG. 1), the photoconductor drum 1Y is scanned with the laser beam L at the position. Thus, an electrostatic latent image corresponding to yellow is formed on the photoconductor drum 1Y (an exposure process).

When the surface of the photoconductor drum 1Y reaches a position facing the developing device 5Y, at the position, the electrostatic latent image is developed with the toner into a yellow toner image (a development process). When the surface of the photoconductor drum 1Y bearing the toner image reaches a position facing a primary transfer roller 9Y via the intermediate transfer belt 8, at the position, the toner image on the photoconductor drum 1Y is transferred onto the intermediate transfer belt 8 (a primary transfer process). After the primary transfer process, a slight amount of untransferred toner remains on the photoconductor drum 1Y.

When the surface of the photoconductor drum 1Y reaches a position opposite the cleaning device 2Y, a cleaning blade 2a of the cleaning device 2Y mechanically collects the untransferred toner on the photoconductor drum 1Y (a cleaning process). Finally, the surface of the photoconductor drum 1Y reaches a position facing the electric-charge removing device, and residual potential on the photoconductor drum 1Y is removed at this position (an electric-charge removing process). Thus, a series of image forming processes performed on the surface of the photoconductor drum 1Y is completed.

The other image forming devices 6M, 6C, and 6K execute the series of image forming processes described above in substantially the same manner as the image forming device 6Y. In other words, the exposure device 7 disposed below the image forming devices 6M, 6C, and 6K irradiates photoconductor drums 1M, 1C, and 1K of the image forming devices 6M, 6C. and 6K, respectively, with the laser beams L based on image data. Then, the toner images formed on the photoconductor drums 1M, 1C, and 1K through the development process are transferred and superimposed on the intermediate transfer belt 8. Thus, a color image is formed on the intermediate transfer belt 8.

With reference to FIG. 1, the intermediate transfer unit 15 includes the intermediate transfer belt 8, the four primary transfer rollers 9Y, 9M, 9C, and 9K, a secondary-transfer counter roller 12, multiple tension rollers, and an intermediate-transfer-belt cleaner. The intermediate transfer belt 8 is stretched around and supported by the multiple rollers and is rotated in the direction indicated by an arrow illustrated in FIG. 1 as a roller (i.e., the secondary-transfer counter roller 12) serving as a drive roller rotates.

Each of the four primary transfer rollers 9Y, 9M, 9C, and 9K nips the intermediate transfer belt 8 with the corresponding one of the photoconductor drums 1Y, 1M, 1C, and 1K to form an area of contact, herein called a primary transfer nip, between the intermediate transfer belt 8 and the corresponding one of the photoconductor drums 1Y, 1M, 1C, and 1K. A primary-transfer bias opposite in polarity to the toner is applied to the primary transfer rollers 9Y, 9M. 9C, and 9K. The intermediate transfer belt 8 travels in the direction indicated by the arrow (counterclockwise) in FIG. 1 and sequentially passes through the primary transfer nips of the primary transfer rollers 9Y, 9M, 9C, and 9K. As a result, the single-color toner images on the photoconductor drums 1Y, 1M, 1C, and 1K, having the respective colors, are primarily transferred and superimposed onto the intermediate transfer belt 8, thereby forming the multicolor toner image (a primary transfer process).

Subsequently, the intermediate transfer belt 8 onto which the toner images of the respective colors are transferred and superimposed reaches a position opposite a secondary transfer roller 19. At the position, the intermediate transfer belt 8 is nipped between the secondary-transfer counter roller 12 and the secondary transfer roller 19 to form a secondary transfer nip. The toner images of four colors formed on the intermediate transfer belt 8 are transferred onto a sheet P such as a sheet of paper conveyed to the position of the secondary transfer nip (a secondary transfer process). At that time, the untransferred toner that has not transferred onto the sheet P remains on the surface of the intermediate transfer belt 8. The surface of the intermediate transfer belt 8 then reaches a position opposite the intermediate-transfer-belt cleaner. At the position, the intermediate-transfer-belt cleaner collects the untransferred toner from the surface of the intermediate transfer belt 8. As a result, a series of transfer processes executed on the outer circumferential surface of the intermediate transfer belt 8 is completed.

The sheet P is conveyed from a sheet feeder 26 disposed in a lower portion of the body of the image forming apparatus 100 to the secondary transfer nip via a feed roller 27 and a registration roller pair 28. Specifically, the sheet feeder 26 contains a stack of multiple sheets P such as sheets of paper stacked on one on another. As the feed roller 27 is rotated counterclockwise in FIG. 1, the feed roller 27 feeds a top sheet P of the stack of multiple sheets P in the sheet feeder 26 toward a roller nip between the registration roller pair 28.

The sheet P conveyed to the registration roller pair 28 temporarily stops at a position of the roller nip between the rollers of the registration roller pair 28 that has stopped rotating. Rotation of the registration roller pair 28 is timed to convey the sheet P toward the secondary transfer nip such that the sheet P meets the color image on the intermediate transfer belt 8 at the secondary transfer nip. Thus, the desired color image is transferred onto the sheet P.

Subsequently, the sheet P, onto which the color toner image is transferred at the secondary transfer nip, is conveyed to a position of a fixing device 20. Then, at the position, the color toner image transferred to the surface of the sheet P is fixed on the sheet P by heat and pressure of a fixing belt and a pressure roller. Thereafter, the sheet P is conveyed through the rollers of an output roller pair 29 and ejected to the outside of the image forming apparatus 100. The sheets P ejected by the output roller pair 29 to the outside of the image forming apparatus 100 are sequentially stacked as output images on a stack tray 30. Thus, a series of image forming processes performed by the image forming apparatus 100 is completed.

A detailed description is provided of a configuration and operation of the developing device 5Y of the image forming device 6Y with reference to FIG. 2. The developing device 5Y includes a developing roller 51Y disposed opposite the photoconductor drum 1Y, a doctor blade 52Y disposed opposite the developing roller 51Y, two conveying screws 55Y disposed in developer housings 53Y and 54Y, and a toner concentration sensor 56Y to detect concentration of toner in developer G. The developing roller 51Y includes a magnet and a sleeve. The magnet is secured inside the developing roller 51Y. The sleeve rotates around the magnet. The developer housings 53Y and 54Y contain the two-component developer G including carrier and toner. The developer housing 54Y communicates, via an opening on an upper side thereof, with a downward toner conveyance passage 64Y.

The developing device 5Y described above operates as follows. The sleeve of the developing roller 51Y rotates in a direction indicated by an arrow in FIG. 2. The developer G is carried on the developing roller 51Y by a magnetic field generated by the magnet. As the sleeve rotates, the developer G moves along the outer circumferential surface of the developing roller 51Y.

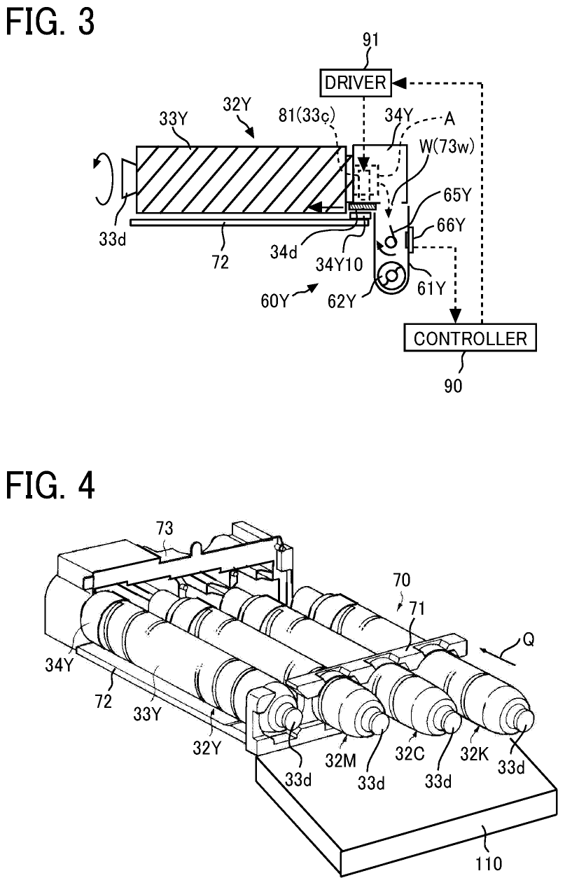

The developer G in the developing device 5Y is adjusted so that the ratio of toner (toner concentration) in the developer G is within a specified range. More specifically, the toner supply device 60Y (see FIG. 3) supplies toner (as powder) from the toner container 32Y to the developer housing 54Y according to the toner consumption in the developing device 5Y. The configuration and operation of the toner supply device are described in detail later.

The two conveying screws 55Y mix and stir the developer G with the toner supplied to the developer housing 54Y while circulating with the developer G in the two developer housings 53Y and 54Y. In this case, the developer G moves in the direction perpendicular to the surface of the plane on which FIG. 2 is illustrated. The toner in the developer G is electrically charged by friction with the carrier and thus is attracted to the carrier. Both the toner and the carrier are borne on the developing roller 51Y due to a magnetic force generated on the developing roller 51Y.

The developer G borne on the developing roller 51Y is conveyed in the direction indicated by the arrow in FIG. 2 and reaches a position opposite the doctor blade 52Y. At the position, the doctor blade 52Y adjusts the amount of the developer G on the developing roller 51Y to an appropriate amount. Thereafter, the developer G on the developing roller 51Y is conveyed to a position opposite the photoconductor drum 1Y (i.c., a developing area). The toner is attracted to the electrostatic latent image formed on the photoconductor drum 1Y by an electric field generated in the developing area. As the sleeve rotates, the developer G remaining on the developing roller 51Y reaches an upper part of the developer housing 53Y and separates from the developing roller 51Y.

With reference to FIGS. 3 and 4, the toner supply devices 60Y, 60M, 60C, and 60K are described in detail below. As illustrated in FIG. 3, the respective color toners in the toner containers 32Y, 32M, 32C, and 32K disposed in the toner container housing 70 in the body of the image forming apparatus 100 are supplied to the corresponding developing devices by the toner supply devices 60Y, 60M, 60C, and 60K provided for the respective color toners according to the amount of toner consumed in the corresponding developing devices. It is to be noted that the four toner supply devices 60Y, 60M, 60C, and 60K have a similar structure, and the four toner containers 32Y, 32M, 32C, and 32K have a similar structure except for the color of toner used in the image forming processes. Therefore, only the toner supply device 60Y and the toner container 32Y for yellow are described below as representatives, and descriptions of the toner supply devices 60M, 60C, and 60K and the toner containers 32M, 32C, and 32K for the other three colors are omitted to avoid redundancy.

As illustrated in FIG. 4, when the toner containers 32Y, 32M, 32C, and 32K are attached (moved in the direction of arrow Q) to the toner container housing 70 (provided with a rail 72 as a mount) of the body of the image forming apparatus 100, shutters 34d of the toner containers 32Y, 32M, 32C, and 32K move in conjunction with an attachment operation to open a toner ejection port W, and toner supply ports 73w (see FIG. 3) of the toner supply devices 60Y, 60M, 60C, and 60K and the toner ejection port W communicate with each other. Accordingly, the toner contained in the toner containers 32Y, 32M, 32C, and 32K is ejected from the toner ejection ports W, passes through the toner supply ports 73w of the toner supply devices 60Y, 60M, 60C, and 60K, and then, is stored in toner tanks 61Y, 61M, 61C, and 61K of the toner supply device 60Y, 60M, 60C, and 60K. With reference to FIG. 3, the toner container 32Y is a substantially cylindrical toner bottle and typically includes a cap 34Y and a container body 33Y (i.e., a bottle body) formed together with a gear 33c (see FIG. 6). The cap 34Y is held by the toner container housing 70 so as not to rotate. The container body 33Y is held so as to be rotatable relative to the cap 34Y and is rotated by a driver 91 (including a drive motor and a drive gear 81) in the direction indicated by an arrow illustrated in FIG. 3. As the container body 33Y rotates, the toner contained in the toner container 32Y (i.e., the container body 33Y) is conveyed in the longitudinal direction by a projection 33b formed spirally on the inner circumferential surface of the container body 33Y (i.e., conveyed from the left side to the right side in FIG. 3). The toner is ejected from the toner ejection port W of the cap 34Y. In other words, the driver 91 drives to rotate the container body 33Y of the toner container 32Y as required, thereby supplying the toner to the toner tank 61Y. The toner containers 32Y, 32M, 32C, and 32K are replaced with new ones when the respective service lives thereof have expired, that is, when almost all toner contained in the respective toner containers 32 has been depleted.

With reference to FIG. 3, the toner supply device 60Y include the toner container housing 70. the toner tank 61Y, a toner conveying screw 62Y, a stirring member 65Y, a toner end sensor 66Y, and the driver 91. The toner tank 61Y is disposed below the toner ejection port W of the toner container 32Y to store the toner ejected through the toner ejection port W of the toner container 32Y. A bottom portion of the toner tank 61Y is coupled to an upstream portion of the toner conveying screw 62Y in the direction in which the toner is conveyed. The toner end sensor 66Y is disposed on a wall face of the toner tank 61Y at a specified height from the bottom portion and detects that the amount of toner stored in the toner tank 61Y has fallen to a specified amount or less. For example, a piezoelectric sensor can be used as the toner end sensor 66Y. When a controller 90 detects that the amount of toner stored in the toner tank 61Y is a predetermined amount or less by the toner end sensor 66Y, the controller 90 controls the driver 91 (e.g., the drive gear 81) to rotate the container body 33Y of the toner container 32Y for a specified time, and to supply toner to the toner tank 61Y. If the toner end sensor 66Y continues to detect “toner end” even when this operation is repeated for a specified number of times, the controller 90 controls to display that the toner container 32Y is empty (toner depletion) on a display panel of the body of the image forming apparatus 100 to prompt a user to replace the toner container 32Y.

The stirring member 65Y is disposed at the center of the toner tank 61Y (near the toner end sensor 66Y) to prevent agglomeration of the toner stored in the toner tank 61Y. The stirring member 65Y includes a shaft and a flexible member disposed on the shaft. The stirring member 65Y rotates clockwise in FIG. 3 to stir the toner in the toner tank 61Y. The tip of the flexible member of the stirring member 65Y slidingly contacts a surface where the toner end sensor 66Y detects in rotation cycles. As a result, the toner does not adhere to the surface detected by the toner end sensor 66Y, thereby preventing the detection accuracy from deteriorating.

The toner conveying screw 62Y conveys the toner stored in the toner tank 61Y obliquely upward. Specifically, the toner conveying screw 62Y conveys the toner linearly from the bottom portion (i.e., bottom point) of the toner tank 61Y toward the upper side of the developing device 5Y. Then, the toner thus conveyed by the toner conveying screw 62Y falls through the downward toner conveyance passage 64Y (see FIG. 2) by its own weight and is supplied to the developing device 5Y (the developer housing 54Y).

With reference to FIG. 4, the toner container housing 70 typically includes a cap receiving portion 73 for holding the cap 34Y of the toner container 32Y, the rail 72 as a mount (an installation portion) for holding the container body 33Y of the toner container 32Y, and an insertion port 71 as an insertion port through which the toner container 32Y is attached.

With reference to FIG. 1, when an opening-and-closing door 110 disposed on the front side of the body of the image forming apparatus 100 (i.e., which is on the front side in the direction perpendicular to the surface of the plane on which FIG. 1 is illustrated) is opened, the toner container housing 70 (e.g., the insertion port 71 and the rail 72) is exposed. The toner containers 32Y, 32M, 32C, and 32K are attached to and detached from the front upper side of the body of the image forming apparatus 100 with the longitudinal direction (a rotation axis direction) of the toner containers 32Y, 32M, 32C, and 32K kept horizontal. In other words, an attachment or detachment operation of each of the toner containers 32Y, 32M, 32C, and 32K is performed with the longitudinal direction (the rotation axis direction) of the toner containers 32Y, 32M, 32C, and 32K as an attachment or detachment direction. The rail 72 (serving as the mount) is formed so that the longitudinal length is almost equal to (or slightly longer than) the longitudinal length of the container body 33Y. The cap receiving portion 73 is disposed on one end (downstream end in the attachment direction) of the rail 72 in the longitudinal direction, and the insertion port 71 is disposed on the other end (upstream end in the attachment direction) of the rail 72 in the longitudinal direction. Accordingly, in the attachment operation of the toner container 32Y into the toner container housing 70, the cap 34Y passes through the insertion port 71, slides on the rail 72 over a certain distance, and is then attached to the cap receiving portion 73.

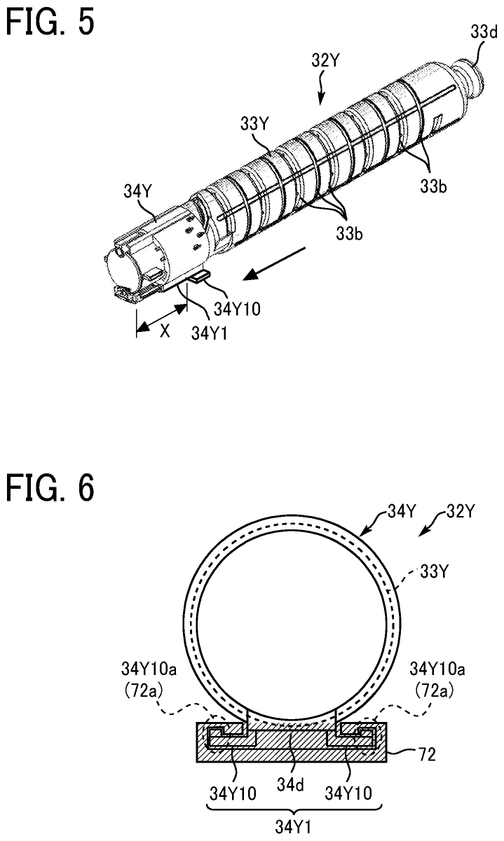

With reference to FIG. 5, the toner containers 32Y, 32M, 32C, and 32K are described in detail. As illustrated in FIG. 5, the toner container 32Y typically includes the cylindrical container body (bottle body) 33Y and the cap (bottle cap) 34Y into which the head of the container body 33Y is inserted. The substantially cylindrical container body 33Y rotates with the rotation axis direction that is a direction in which the toner container 32Y is attached and detached (a left-and-right direction in FIG. 3), to convey toner (powder) stored therein toward an opening portion A. In the cap 34Y, a head portion of the container body 33Y in which the opening portion A is formed is inserted, and the toner ejection port W for ejecting the toner ejected from the opening portion A to the outside of the container body 33Y is disposed in a bottom portion 34Y1.

With reference to FIG. 3, in the head portion of the substantially cylindrical container body 33Y, the gear 33c that rotates integrally with the container body 33Y, and the opening portion A are disposed on one end in the rotation axis direction (left-and-right direction of FIG. 3, and a direction perpendicular to the surface of the plane on which FIG. 6 is illustrated). The opening portion A is formed on the head portion of the container body 33Y (i.e., a leading side when the toner container 32Y is inserted into the toner container housing 70). The toner contained in the container body 33Y is ejected through the opening portion A to a space (a cavity) inside the cap 34Y. A toner conveyance from an inside of the container body 33Y to the cavity in the cap 34Y (i.e., a rotational drive by the container body 33Y) is appropriately performed so that the toner in the cap 34Y does not go below a specified waterline.

The gear 33c of the container body 33Y meshes with the drive gear 81 disposed in the toner container housing 70 of the body of the image forming apparatus 100 to drive to rotate the container body 33Y in the direction indicated by the arrow in FIG. 3 with the longitudinal direction as the rotation axis direction. Specifically, the gear 33c is formed to go around the opening portion A, and a plurality of teeth are formed radially with respect to the rotation center of the container body 33Y. A part of the gear 33c is exposed from a notch (see FIG. 6) formed in the cap 34Y, and the gear 33c meshes with the drive gear 81 of the body of the image forming apparatus 100 at a meshing position located obliquely below the gear 33c. A driving force is transmitted from the drive gear 81 to the gear 33c, and the container body 33Y rotates in a specified direction.

With reference to FIGS. 4 and 5, a grip 33d gripped when a user attaches and detaches the toner container 32Y is disposed on the other end of the container body 33Y in the longitudinal direction (i.e., on the rear end in the attachment direction). The user grips the grip 33d to attach the toner container 32Y to the body of the image forming apparatus 100 (the rail 72), which is a movement in the direction indicated by the arrow illustrated in FIG. 5.

The spiral projection 33b (illustrated in FIG. 5) protruding inward is formed on an inner circumferential face of the container body 33Y. In other words, a spiral groove is formed in an outer circumferential face of the container body 33Y when viewed from outside as illustrated in FIG. 5. The spiral projection 33b is for ejecting toner contained in the container body 33Y through the opening portion A. As the container body 33Y rotates in the longitudinal direction as the rotation axis direction, the spiral projection 33b conveys the toner toward the opening portion A and ejects the toner from the opening portion A. The container body 33Y having such a configuration is formed from a resin material such as polyethylene terephthalate (PET), and can be integrally manufactured by blow molding with the gear 33c and the grip 33d disposed on a circumferential surface thereof.

With reference to FIGS. 3, 5, and 6, the cap 34Y of the toner container 32Y is provided with, for example, a shutter 34d and a projection 34Y10 in the bottom portion 34Y1 thereof. The opening portion A of the container body 33Y is inserted into the cap 34Y. In the bottom portion 34Y1 of the cap 34Y, the toner ejection port W is formed for ejecting (falling by its own weight) the toner ejected from the opening portion A of the container body 33Y vertically downward and outside the container body 33Y. The shutter 34d (sec FIGS. 2 and 6) for opening-and-closing the toner ejection port W is held in a slidable manner in a bottom portion 34Y1 of the cap 34Y. Specifically, the shutter 34d opens the toner ejection port W by a relative movement in the longitudinal direction (i.e., a movement in the direction opposite to the direction indicated by the arrow in FIG. 5) from the cap 34Y toward the container body 33Y. The shutter 34d closes the toner ejection port W by a relative movement in the longitudinal direction (i.e., a movement in the direction indicated by the arrow in FIG. 5) from the container body 33Y toward the cap 34Y. Opening and closing of the shutter 34d (opening-and-closing of the toner ejection port W) are performed in conjunction with the attachment and detachment operations of the toner container 32Y relative to the toner container housing 70 (the rail 72) in the longitudinal direction (the rotation axis direction).

The cap 34Y having such a configuration communicates with the container body 33Y via the opening portion A, and the toner ejected from the opening portion A is ejected through the toner ejection port W (i.e., a movement in the direction indicated by broken arrow illustrated in FIG. 3). In the present embodiment, a substantially cylindrical cavity (space) is formed inside the cap 34Y to extend in the longitudinal direction. In addition, a cylindrical toner dropping path having a fixed channel area (cross-sectional channel area) extends from a lower circumferential face of the substantially columnar cavity to the toner ejection port W in the cap 34Y. With this configuration, the toner ejected from the opening portion A of the container body 33Y to the cavity in the cap 34Y drops through the toner ejection port W smoothly outside the container (the toner tank 61Y) by its own weight.

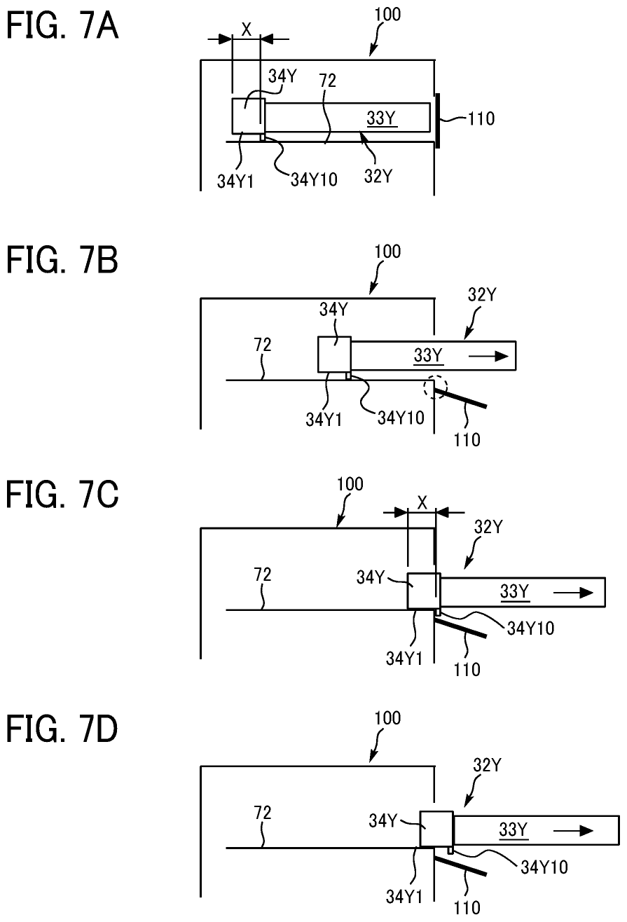

A description is given of a configuration and an operation of the toner container 32Y (32M, 32C, 32K) according to the present embodiment below. As described above with reference to FIGS. 1 to 5, the toner container 32Y according to the present embodiment is formed to be manually attachable to or detachable from the rail 72 as a mount of the body of the image forming apparatus 100 horizontally in the attachment or detachment direction. Specifically, when the toner container 32Y set in the body of the image forming apparatus 100 (the rail 72) is detached from the body of the image forming apparatus 100, first, the opening-and-closing door 110 is opened as illustrated in FIG. 7A. In a state where the opening-and-closing door 110 is opened and the toner container 32Y placed on the rail 72 is exposed, the toner container 32Y is pulled out in the direction indicated by the arrow in a state where the grip 33d (see FIG. 5) is held by a user with one hand as illustrated in FIGS. 7B to 7D. Specifically, the toner container 32Y is detached while the cap 34Y (the projection 34Y10) slides on the rail 72. When the toner container 32Y is manually attached to the body of the image forming apparatus 100 (the rail 72), an operation is manually performed in a procedure opposite to the procedure of FIGS. 7A to 7D described above.

With reference to FIG. 6 (and FIGS. 5 to 7D), in the toner container 32Y according to the present embodiment, a projection 34Y10 is formed to protrude downward to the lowest position in the bottom portion 34Y1 of the toner container 32Y in a posture (postures illustrated in FIGS. 3 to 7D) when the toner container 32Y is attached to and detached from the rail 72 as a mount. The projection 34Y10 slides on the surface of the rail 72 when the toner container 32Y is attached to and detached from the rail 72 (the mount). In this way, since the toner container 32Y is attached and detached while sliding only the projection 34Y10 on the rail 72, the attachment operation and the detachment operation can be smoothly performed with a small resistance force as compared with a case where the entire bottom portion 34Y1 of the cap 34Y (or the entire bottom of the toner container 32Y). In order to further enhance such an advantageous effect, the bottom surface of the projection 34Y10 may be formed of a low friction material.

Specifically, when the toner container 32Y is manually attached to the rail 72 (the mount) with the cap 34Y placed as a leading position of the container body 33Y in the attachment direction, the projection 34Y10 that protrudes downward in the bottom portion 34Y1 formed on the cap 34Y slides to slide on the rail 72. In the present embodiment, as illustrated in FIG. 6, the projections 34Y10 are formed to protrude on both sides in the short-length direction (the direction orthogonal to the longitudinal direction, e.g., the left-and-right direction in FIG. 6) in the bottom portion 34Y1 of the cap 34Y. The bottom surface of the projection 34Y10 is formed horizontally. As illustrated in FIG. 6, the projections 34Y10 are formed to sandwich the shutter 34d and to protrude downward relative to the shutter 34d when viewed in the rotation axis direction of the toner container 32Y. As illustrated in FIGS. 7A to 7D, the projection 34Y10 is formed at an upstream end of the bottom portion 34Y1 of the cap 34Y in the attachment direction (which is on the right side in FIGS. 7A to 7D, and also near the container body 33Y). In the bottom portion 34Y1 of the cap 34Y, a range (which is a range of a length X) from the projection 34Y10 to a downstream end of the bottom portion 34Y1 (which is on the left side in FIG. 7) in the attachment direction is parallel to the bottom surface of the projection 34Y10 and horizontal.

With reference to FIGS. 5, 7A, 7B, 7C, and 7D, in the present embodiment, the bottom portion 34Y1 of the cap 34Y is formed so that the length X from the downstream end (which is on the left side in FIG. 7) in the attachment direction (which is the direction indicated by the arrow in FIG. 5) of the attachment and detachment directions to the projection 34Y10 is within a range of 37.5 to 80 mm. In other words, when the toner container 32Y is viewed in the longitudinal direction, the length X from a leading end (an end face on the downstream side in the attachment direction) of the bottom portion 34Y1 of the cap 34Y to the projection 34Y10 is within a range of 37.5 to 80 mm.

With such a configuration, when the toner container 32Y is pulled out of the body of the image forming apparatus 100 by a user (an operator), a failure in which the posture of the toner container 32Y is significantly unbalanced is less likely to occur even if the projection 34Y10 falls off from the rail 72 (which is a rail-shaped mount). Accordingly, the failure that the toner container 32Y (the projection 34Y10) falls off from the rail 72, the posture of the toner container 32Y is unbalanced, and the toner remaining in the toner container 32Y leaks to the outside is less likely to occur.

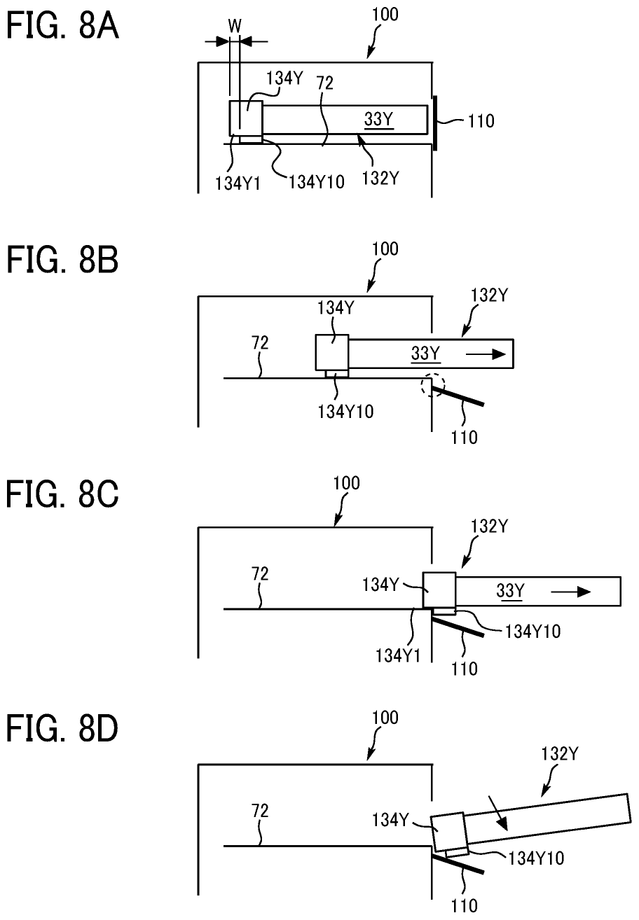

A description is given of the above-described configuration in more detail below. Generally, it is said that the reflection time of an average person (a time required for a person having average reflexes to perform an action after understanding a phenomenon in at least one of five senses) is 0.2 to 0.25 seconds. The present inventors have conducted an experiment to measure the pulling-out speed when a user who is unfamiliar with the operation of removing the toner container 32Y takes out the toner container 32Y from the body of the image forming apparatus 100, and as a result, have found that the pulling-out speeds of many users are 150 mm/s or less. As a result, during the pulling-out operation of the toner container 32Y, the toner container 32Y is pulled out by a length of only substantially 37.5 mm (=0.25 seconds×150 mm) before a user feels any abnormality and stops the pulling-out operation. For example, in the case of a toner container 132Y according to a comparative example illustrated in FIGS. 8A to 8D, the length W from the leading end of a cap 134Y to a projection 134Y10 in a bottom 134Y1 of the cap 134Y is set to less than 37.5 mm. In such a case, at the moment at which the projection 134Y10 completely comes out of the rail 72 when a user pulls out the toner container 132Y by gripping the grip 33d (see FIGS. 3 to 5) with one hand, the support of a portion near the cap 134Y is lost and the toner container 132Y is unbalanced. As a result, the user misses a timing to support the toner container 132Y (the portion near the cap 134Y) that has fallen off the rail 72 by the other hand (which is not the hand holding the grip 33d). In other words, immediately after the toner container 132Y (the projection 134Y10) has fallen off the rail 72, as illustrated in FIG. 8D, the posture of the toner container 132Y is largely unbalanced as a whole (the toner container 132Y cannot be maintained in a horizontal posture and turns to be a largely inclined posture), and the toner remaining in the toner container 132Y is likely to leak to the outside of the toner container 132Y. In particular, in a case where the toner container 132Y whose posture is unbalanced is dropped onto a floor surface. toner leakage may be conspicuous. In contrast, in the present embodiment, as illustrated in FIGS. 7A to 7D, the length X from the leading end of the cap 34Y to the projection 34Y10 of the bottom portion 34Y1 of the cap 34Y is set to be 37.5 mm or more. Accordingly, even if the support of the projection 34Y10 is lost at the moment at which the projection 34Y10 completely comes out of the rail 72 when a user pulls out the toner container 32Y by gripping the grip 33d (see FIGS. 3 to 5) with one hand, a portion of the cap 34Y that extends from the projection 34Y10 to the leading end of the cap 34Y (the portion indicated by length X) is placed on the rail 72. Thus, a time required for supporting the toner container 32Y (the side near the cap 34Y) with the other hand (which is not the hand holding the grip 33d) is sufficiently ensured without significant unbalance of the horizontal posture of the toner container 32Y. As a result, even if the toner container 32Y (the projection 34Y10) drops from the rail 72, the posture is not significantly unbalanced (the horizontal posture is maintained) as illustrated in FIG. 7D at that time. Thus, the toner remaining in the toner container 32Y is not likely to leak to the outside of the toner container 32Y.

The inventors of the present disclosure have found that, when a user feels something unusual during the operation of detaching the toner container 32Y from the body of the image forming apparatus 100, the user holds the grip 33d with one hand and puts the other hand to the toner container 32Y that has been pulled out, and have found that, in a case where nothing happens even if the user pulls out the toner container 32Y by about 80 mm after feeling something unusual, the user removes the other hand putting to the toner container 32Y from the toner container 32Y. Accordingly, in the present embodiment, the upper limit value of the length X from the leading end (the end face on the downstream side in the attachment direction) of the bottom portion 34Y1 of the cap 34Y to the projection 34Y10 is set to be 80 mm or less.

With reference to FIGS. 7A to 7D (and FIG. 4), in the image forming apparatus 100 according to the present embodiment, the opening-and-closing door 110 that is opened and closed when the toner container 32Y is attached to and detached from the rail 72 (the mount) is disposed to be rotatable around a supporting shaft. When the opening-and-closing door 110 is opened, a step (a portion surrounded by a broken line in FIG. 7B) is formed between the rail 72 (the mount) exposed to the inside of the body of the image forming apparatus 100 and the opening-and-closing door 110 so that the opening-and-closing door 110 is positioned below the rail 72. As illustrated in FIG. 8D, in a case where a step is formed in such a manner, the posture of the toner container 132Y is more likely to be significantly unbalanced when the projection 134Y10 of the toner container 32Y passes through the rail 72 than in a case where no step is formed. As a result, the above-described effect of the present disclosure (which is an effect achieved by setting the length X from the leading end of the bottom portion 34Y1 of the cap 34Y to the projection 34Y10 to be long) is more likely to be achieved.

With reference to FIG. 6, in the present embodiment, in the toner container 32Y in the posture when the toner container 32Y is attached to and detached from the rail 72 (the mount), the lower end of the projection 34Y10 in the bottom portion 34Y1 of the cap 34Y is positioned lower than the container body 33Y. Such a configuration facilitates smooth sliding of the projection 34Y10 on the rail 72 when the toner container 32Y is attached to and detached from the rail 72.

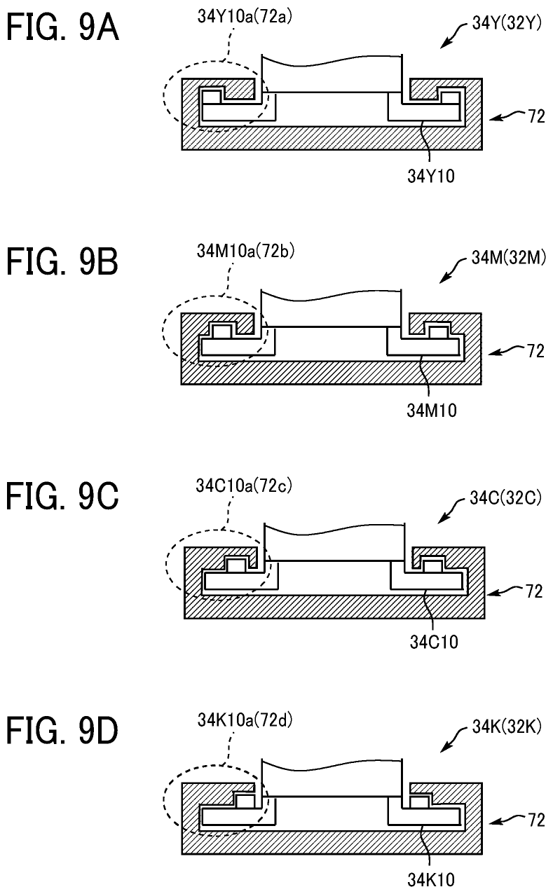

In the present embodiment, the bottom portion 34Y1 of the cap 34Y is provided with fitting portions 34Y10a as incompatible-shape portions formed to have a different shape according to at least one of the colors of the toner stored in the toner container 32Y and the model of the body of the image forming apparatus 100. Specifically, as illustrated in FIG. 9A, in the yellow toner container 32Y in which yellow toner is stored, the substantially rectangular parallelepiped-shaped fitting portions 34Y10a (incompatible-shape portions) are formed at both outermost ends of an upper area of the projection 34Y10 in the bottom portion 34Y1 of the cap 34Y. A fitted portion 72a (incompatible-shape portion near the mount) that fits with the fitting portion 34Y10a (incompatible-shape portion) for yellow is formed in the rail 72 in which the toner container 32Y for yellow is set. In contrast, as illustrated in FIG. 9B, substantially rectangular parallelepiped fitting portions 34M10a (incompatible-shape portions) are formed at positions shifted from both outermost ends of an upper area of a projection 34M10 toward the central in a bottom portion 34M1 of a cap 34M of the magenta toner container 32M in which magenta toner is stored. A fitted portion 72b (incompatible-shape portion near the mount) that fits with the fitting portion 34M10a (incompatible-shape portion) for magenta is formed in the rail 72 in which the toner container 32M for magenta is set. As illustrated in FIG. 9C, substantially rectangular parallelepiped fitting portions 34C10a (incompatible-shape portions) are formed at positions shifted from both outermost ends of an upper area of a projection 34C10 toward the central in a bottom portion 34C1 of a cap 34C of the cyan toner container 32C in which cyan toner is stored. A fitted portion 72c (incompatible-shape portion near the mount) that fits with the fitting portion 34C10a (incompatible-shape portion) for cyan is formed in the rail 72 in which the toner container 32C for cyan is set. As illustrated in FIG. 9D, substantially rectangular parallelepiped fitting portions 34K10a (incompatible-shape portions) are formed at positions shifted from both outermost ends of an upper area of a projection 34K10 toward the central in a bottom portion 34K1 of a cap 34K of the black toner container 32K in which black toner is stored. A fitted portion 72d (incompatible-shape portion near the mount) that fits with the fitting portion 34K10a (incompatible-shape portion) for black is formed in the rail 72 in which the toner container 32K for black is set.

With such a configuration, the toner containers 32Y, 32M, 32C, and 32K of the four colors cannot be installed to the rails for the different colors from each other, and incompatibility is ensured. Accordingly, a failure that a user erroneously installs a toner container to the rail for the toner container for a different color. Since the projections 34Y10, 34M10, 34C10, and 34K10 are disposed at the appropriate distances X in the toner containers 32Y, 32M, 32C, and 32K of the four colors, a failure that the postures of the toner containers 32Y, 32M, 32C, and 32K are unbalanced can be prevented from occurring when the toner containers 32Y, 32M. 32C, and 32K are pulled out of the body of the image forming apparatus 100. The incompatible-shape portions formed in the projections 34Y10, 34M10, 34C10, and 34K10 are not limited to those illustrated in FIGS. 9A to 9D, and portions having various shapes and numbers can be used. In the examples of FIGS. 9A to 9D, the incompatible-shape portion is formed to have a different shape according to the color of the toner contained in the toner container. The incompatible-shape portion can be formed to have a different shape according to the model of the body of the image forming apparatus 100 (for example, destination, presence or absence of original equipment manufacturing (OEM), or version), or the incompatible-shape portion can be formed to have a different shape according to both the color of the toner and the model of the body.

As described above, the toner container 32Y according to the present embodiment is manually attachable to and detachable from the rail 72 (the mount) of the body of the image forming apparatus 100. The toner container 32Y is provided with the projection 34Y10 that is formed to protrude downward to the lowest position in the bottom portion 34Y1 of the toner container 32Y in a posture at the time of attachment to and detachment from the rail 72 and slides on the surface of the rail 72 at the time of attachment to and detachment from the rail 72. The bottom portion 34Y1 is formed so that the length X from the end on the downstream side in the attachment direction of the attachment and detachment directions to the projection 34Y10 is within a range of 37.5 to 80 mm. As a result, a failure that the posture of the toner container 32Y is unbalanced when the toner container 32Y is pulled out of the body of the image forming apparatus 100 by a user can be reduced.

In the present embodiment, only toner is stored in the toner containers 32Y, 32M, 32C, and 32K. However, in some embodiments, toner containers may contain two-component developer including toner and carrier to be used in an image forming apparatus in which the two-component developer is appropriately supplied to developing devices. In the present embodiment, although the present disclosure is applied to the substantially cylindrical (bottle-shaped) toner container 32Y, the toner container to which the present disclosure is applied is not limited to this. The present disclosure can be applied to, for example, a box-shaped toner container as long as a projection is disposed on the bottom portion. Even in such a case, similar effects to the above-described embodiments are also attained.

In the present embodiment, at least one of the image forming units 6Y, 6M, 6C, and 6K may be used as a process cartridge. Even in such a case, similar effects to the above-described embodiments are also attained. Note that the term “process cartridge” used in the present disclosure defines a unit that includes an image bearer united with at least one of a charging device to charge the image bearer, a developing device to develop a latent image on the image bearer, and a cleaning device to clean the image bearer, and that is removably attached to a body of an image forming apparatus.

Note that embodiments of the present disclosure are not limited to the above-described embodiments and it is apparent that the above-described embodiments can be appropriately modified within the scope of the technical idea of the present disclosure in addition to what is suggested in the above-described embodiments. Further, the number, position, shape, and so forth of components are not limited to those of the present embodiment and variations, and may be the number, position, shape, and so forth that are suitable for implementing the present disclosure.

Note that in the description of the present disclosure, the term “horizontal” is defined to include a state close to horizontal (substantially horizontal).

Aspects of the present disclosure may be, for example, combinations of first to seventh aspects as follows.

### First Aspect

A toner container (e.g., the toner container 32Y) is manually attachable to a body of an image forming apparatus (e.g., the image forming apparatus 100) horizontally in an attachment direction and detachable from the mount (e.g., the rail 72) horizontally in a detachment direction. The toner container includes a bottom portion (e.g., the bottom portion 34Y1) and a projection (e.g., the projection 34Y10). The projection protrudes downward to the lowest position in the bottom portion of the toner container in a posture when the toner container is attached to and detached from the mount, and slides on a surface of the mount when the toner container is attached to and detached from the mount. A length from a downstream end of the bottom portion in the attachment direction to the projection is within a range of 37.5 to 80 mm.

### Second Aspect

The toner container (e.g., the toner container 32Y) according to the first aspect includes a substantially cylindrical container body (e.g., the container body 33Y) that rotates with the attachment direction as a rotation axis direction of the container body and conveys toner stored in the container body toward an opening portion (e.g., the opening portion A) of the container body and a cap (e.g., the cap 34Y) into which a head portion of the container body provided with the opening portion is inserted. The cap includes a toner ejection port (e.g., the toner ejection port W) through which the toner ejected from the opening portion is ejected outside the toner container.

### Third Aspect

The toner container (e.g., the toner container 32Y) according to the second aspect is to be attached to the mount (e.g., the rail 72) with the cap (e.g., the cap 34Y) placed as a leading position of the container body (e.g., the container body 33Y) in the attachment direction. The bottom portion (e.g., the bottom portion 34Y1) is on the cap.

### Fourth Aspect

In the toner container (e.g., the toner container 32Y) according to any one of the second or third aspect, in a case where the toner container is in the posture when the toner container is attached to and detached from the mount (e.g., the rail 72), a lower end of the projection (e.g., the projection 34Y10) at the bottom portion (e.g., the bottom portion 34Y1) of the cap is positioned lower than the container body (e.g., the container body 33Y).

### Fifth Aspect

In the toner container (e.g., the toner container 32Y) according to any one of the first to fourth aspects, the bottom portion (e.g., the bottom portion 34Y1) includes an incompatible-shape portion (e.g., the fitting portion 34Y10a) having a different shape according to at least one of a color of toner stored in the toner container and a model of the body of the image forming apparatus (e.g., the image forming apparatus 100).

### Sixth Aspect

An image forming apparatus (e.g., the image forming apparatus 100) includes the toner container (e.g., the toner container 32Y) according to any one of the first to fifth aspects. The toner container is detachably attached to the mount (e.g., the rail 72) of the body of the image forming apparatus.

### Seventh Aspect

The image forming apparatus (e.g., the image forming apparatus 100) according to the sixth aspect includes an opening-and-closing door (e.g., the opening-and-closing door 110) to open and close when the toner container (e.g., the toner container 32Y) is attached to and detached from the mount (e.g., the rail 72). When the opening-and-closing door is opened, a step difference that causes the opening-and-closing door to be positioned below the mount is generated between the mount exposed to an inside of the body of the image forming apparatus and the opening-and-closing door.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2023-009351, filed on Jan. 25, 2023, in the Japan Patent Office, the entire disclosure of which is hereby incorporated by reference herein.

### REFERENCE SIGNS LIST

5Y Developing device
32Y, 32M, 32C, 32K Toner container (Powder container)
33Y Container body
34Y Cap
34Y1 Bottom portion
34Y10 Projection
34Y10a Fitting portion (Incompatible-shape portion)
60Y, 60M, 60C, 60K Toner supplying device
70 Toner container housing
72 Rail (Mount)
72a Fitted portion (Incompatible-shape portion near mount)
100 Image forming apparatus (Body of image forming apparatus)
110 Opening-and-closing door

1. A toner container for use with a mount of a body of an image forming apparatus horizontally in an attachment direction and detachable from the mount horizontally in a detachment direction, the toner container comprising:
a bottom portion; and
a projection protruding downward to a lowest position in the bottom portion of the toner container in a posture when the toner container is attached to and detached from the mount, the projection to slide on a surface of the mount when the toner container is attached to and detached from the mount,
wherein a length from a downstream end of the bottom portion in the attachment direction to the projection is within a range of 37.5 to 80 mm.

2. The toner container according to claim 1, further comprising:
a substantially cylindrical container body including an opening portion, the substantially cylindrical container body to:
rotate with the attachment direction as a rotation axis direction of the container body; and
convey toner stored in the container body toward the opening portion of the container body; and
a cap into which a head portion of the container body, the cap including a toner ejection port through which the toner ejected from the opening portion is ejected outside the toner container.

3. The toner container according to claim 2, wherein;
the toner container is to be attached to the mount with the cap placed as a leading position of the container body in the attachment direction, and
the bottom portion is on the cap.

4. The toner container according to claim 2, wherein:
in a case where the toner container is in the posture when the toner container is attached to and detached from the mount, a lower end of the projection at the bottom portion is positioned lower than the container body.

5. The toner container according to claim 1, wherein:
the bottom portion includes an incompatible-shape portion having a different shape according to at least one of a color of toner stored in the toner container and a model of the body of the image forming apparatus.

6. An image forming apparatus comprising the toner container according to claim 1, wherein:
the toner container is detachably attached to the mount of the body of the image forming apparatus.

7. The image forming apparatus according to claim 6, further comprising:
an opening-and-closing door to open and close when the toner container is attached to and detached from the mount,
wherein when the opening-and-closing door is open, a step difference that causes the opening-and-closing door to be positioned lower than the mount is generated between the opening-and-closing door and the mount exposed to an inside of the body of the image forming apparatus.
